(19) United States
(12) Patent Application Publication
(10) Pub. No.: US 2005/0216542 A1
(43) Pub. Date: Sep. 29, 2005

(54) Transform domain adaptive filter, equalizer and wireless communication device using the same, and decision feedback equalization method

(75) Inventor: Wei-Shun Liao, Taipei County (TW)

Correspondence Address: SNELL & WILMER;ONE ARIZONA CENTER, 400 EAST VAN BUREN, PHOENIX, AZ, 850040001, US

(73) Assignee: BENQ CORPORATION

(21) Appl. No.: 11/088,533

(22) Filed: Mar. 24, 2005

(30) Foreign Application Priority Data
Mar. 25, 2004 (TW) 93108114

(51) Int. Cl. G06F 17/10

(52) U.S. Cl. 708/322

(57) ABSTRACT

A transform domain adaptive filter (TDAF) is provided. The transform domain adaptive filter includes a filter device, a computing device and an adaptive algorithmic device. The filter device has a transform matrix device for pre-whitening an input signal to obtain a pre-whitened signal. The filter device restores the pre-whitened signal to a restored signal. The computing device compares the restored signal with a reference signal to obtain an error signal. The adaptive algorithmic device adjusts a filter coefficient of the filter device. The adaptive algorithmic device adopts the normalized least mean square (NLMS) algorithm.

### CROSS-REFERENCE TO RELATED APPLICATIONS

This application claims priority of Taiwan Patent Application Serial No. 093108114 entitled “TRANSFORM DOMAIN ADAPTIVE FILTER, EQUALIZER AND WIRELESS COMMUNICATION DEVICE USING THE SAME, AND DECISION FEEDBACK EQUALIZATION METHOD,” filed on Mar. 25, 2004.

### FIELD OF INVENTION

The present invention relates to a transform domain adaptive filter, an equalizer and a wireless communication device using the transform domain adaptive filter, and a decision feedback equalization method.

### BACKGROUND OF THE INVENTION

In communication systems, the channel usually affects the signal transmission, so that an equalizer is required to restore the signal. A typical equalizer, shown in FIG. 6, includes an adaptive filter 601, a decision device 602, a signal generator 604, a computing device 606, and a multiplexer 608. The multiplexer 608 is controlled by a signal CS′ and selects one of signals, generated by the decision device 602 and the signal generator 604, as a reference signal d′(n). In the training stage, a training signal x(n) is sent to the adaptive filter 601 to obtain a restored signal y′(n). At the same time, a signal, which is the same as the training signal, is also generated by the signal generator 604 and outputted by the multiplexer 608 as the reference signal d′(n). An error signal e′(n) is computed by the computing device 606 and sent as feedback to the adaptive filter 601. In this way, the adaptive filter 601 is tuned to be an inverse channel filter which is adapted to restore the input signal. The decision device 602 compares the restored signal y′(n) with a plurality of predetermined signals, and sends one of the plurality of the predetermined signals as an output signal s″(n) of the equalizer. The output signal s″(n) is also sent back to the multiplexer 608. After the training stage, the output signal s″(n) chosen by the decision device 602 is used as the reference signal d′(n).

However, the convergence speed of the adaptive filter depends on the characteristics of the input signal. Once the characteristics of the input signal cause degradation of the convergence speed of the adaptive filter 601 used in the equalizer of FIG. 6, the overall performance of the equalizer is also affected. Therefore, an adaptive filter and a decision feedback equalization method for improving the convergence speed are required for an equalizer or a wireless communication device.

### SUMMARY OF THE INVENTION

One aspect of the present invention is to provide an adaptive filter and a decision feedback equalization method for improving the convergence speed in an equalizer or a wireless communication device. The present invention uses a transform domain adaptive filter (TDAF), having a transform matrix, as the adaptive filter. The transform matrix decorrelates the input signal for pre-whitening the signal to improve the convergence speed. The TDAF adopts the normalized least mean square (NLMS) algorithm as the adaptive algorithm to assure the output stability of the filter.

The present invention provides a transform domain adaptive filter including a filter device, a computing device and an adaptive algorithmic device. The filter device has a transform matrix device for pre-whitening an input signal to obtain a pre-whitened signal. The filter device restores the pre-whitened signal to a restored signal. The computing device compares the restored signal with a reference signal to obtain an error signal. The adaptive algorithmic device, responsive to the error signal, adjusts a filter coefficient of the filter device. The adaptive algorithmic device adopts the normalized least mean square (NLMS) algorithm.

The transform matrix device may adopt Walsh-Hadamard Transform (WHT). The adaptive algorithmic device may adjust the filter coefficient according to the pre-whitened signal. The adaptive algorithmic device may further include a power-computing unit for computing a power value of the pre-whitened signal. The adaptive algorithmic device may further include an adder for adding the power value with a predetermined constant to obtain a non-zero first temporary value. The adaptive algorithmic device may still further include a divider for dividing a step size constant by the first temporary value to obtain a second temporary value for performing normalization operation. The adaptive algorithmic device may further include a multiplier for multiplying the second temporary value by the error signal to obtain a feedback signal, and the feedback signal is used for adjusting the filter coefficient.

The present invention provides an equalizer including the filter device, the computing device, and the adaptive algorithmic device as described above. The equalizer may further include a decision device for choosing one of a plurality of predetermined signals as the reference signal by comparing the restored signal with the plurality of predetermined signals. The equalizer may still further include a signal generator for generating the reference signal.

The present invention provides a wireless communication device including the equalizer described above.

The present invention also provide an (n)-iterations decision feedback equalization method for an input signal x(n), and the input signal x(n) being generated from a source signal s(n) by a channel having a transfer function H(z). The method includes the following steps: the input signal x(n) is pre-whitened to generate a pre-whitened signal p(n); the pre-whitened signal p(n) is processed with a decision feedback equalization including the (n)-iterations to generate an output signal s′(n) corresponding to the source signal s(n). Each of the (n)-iterations generates a restored signal y(n), an error signal e(n), and a feedback signal f(n). The error signal e(n) is generated by comparing the restored signal y(n) with a reference signal d(n). The feedback signal f(n) is generated based on the error signal e(n). The feedback signal f(n) is generated by multiplying a step size constant μ by the error signal e(n), and then divided by a power value of the whitened signal p(n).

The pre-whitening step of the decision feedback equalization method may adopt a Walsh-Hadamard Transform (WHT). The reference signal d(n) may be the same as the source signal s(n). Alternatively, the reference signal d(n) may be generated by the following steps: the restored signal y(n) is compared with a plurality of predetermined signals; one of the predetermined signals is outputted as the reference signal.

### BRIEF DESCRIPTION OF THE DRAWINGS

FIG. 1 is a block diagram of a transfer domain adaptive filter in accordance with an embodiment of the present invention;

FIG. 2 is a block diagram of one embodiment of the adaptive algorithmic device shown in FIG. 1;

FIG. 3 is a block diagram of an equalizer in accordance with an embodiment of the present invention;

FIG. 4 is a schematic view of a wireless communication device in accordance with an embodiment of the present invention;

FIG. 5 is a flowchart of a decision feedback equalization method in accordance with an embodiment of the present invention; and

FIG. 6 is a block diagram of an equalizer in the prior art.

### DETAILED DESCRIPTION

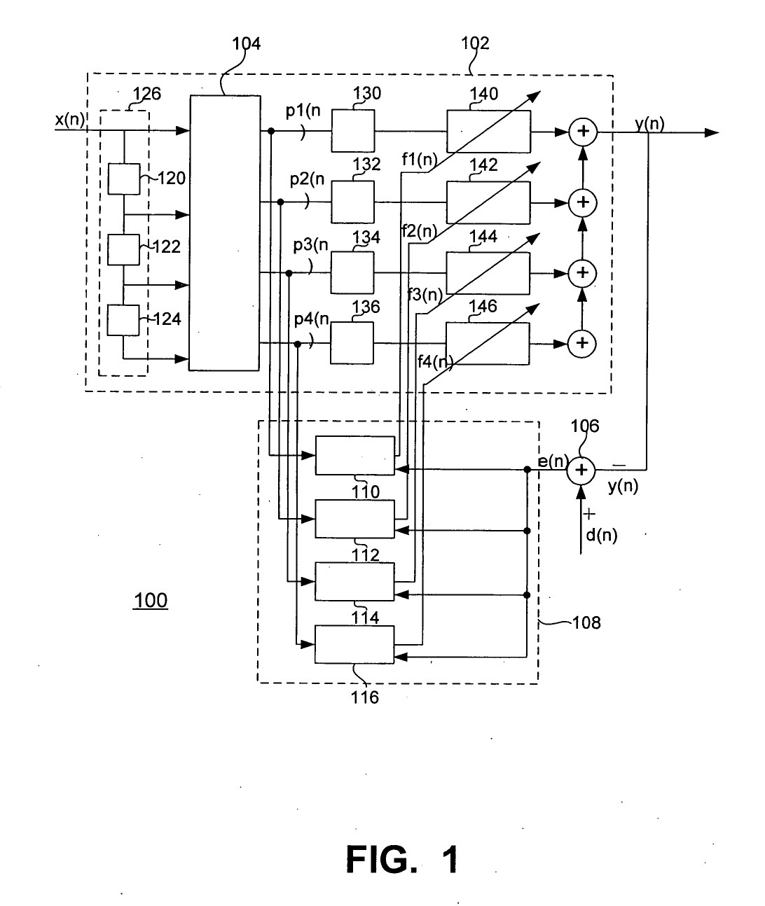

FIG. 1 is a block diagram of a transfer domain adaptive filter 100 in accordance with an embodiment of the present invention. The transform domain adaptive filter (TDAF) 100 includes a filter device 102, a computing device 106 and an adaptive algorithmic device set 108. In this embodiment, the TDAF 100 is a 24-levels TDAF implementing a 4×4 transform matrix device 104 with four 6-levels adaptive filter units 140, 142, 144, and 146.

The filter device 102 restores a signal x(n) to a restored signal y(n). The signal x(n) is sent, split in four lines, into the transform matrix device 104 through a delay line 126 including delay units 120, 122, and 124. The transform matrix device 104 decorrelates the signal x(n) for pre-whitening the signal to improve the convergence speed. In this embodiment, the transform matrix device 104 may adopt Walsh-Hadamard Transform (WHT). In other embodiments, however, the transform matrix device 104 may adopt Discrete Fourier Transform (DFT), Real Discrete Fourier Transform (RDFT), Discrete Hartley Transform (DHT), Discrete Cosine Transform (DCT), discrete Sine Transform (DST), or the like. After the pre-whitening process, the signal x(n) is pre-whitened to generate pre-whitened signals p1(n), p2(n), p3(n), and p4(n). The pre-whitened signals are sent to the adaptive filter units 140, 142, 144, and 146 respectively through the down sampling units 130, 132, 134, and 136. The outputs of adaptive filter units 140-146 are combined and then outputted as a restored signal y(n).

The computing device 106 compares the restored signal y(n) with a reference signal d(n) to obtain an error signal e(n). In this embodiment, the error signal e(n) is generated by subtracting the restored signal y(n) from the reference signal d(n).

The adaptive algorithmic device set 108 may include adaptive algorithmic devices 110, 112, 114, and 116. The adaptive algorithmic devices 110-116 may adopt the normalized least mean square (NLMS) algorithm to assure stability of the output signal y(n) in this embodiment. In this embodiment, the adaptive algorithmic devices 110-116 utilize error signal e(n) with pre-whitened signals p1(n)-p4(n) to respectively generate feedback signals f1(n), f2(n), f3(n), and f4(n). The feedback signals are utilized for adjusting filter coefficients of the adaptive filter units 140-146 and the TDAF 100 is trained to be an inverse system of the channel.

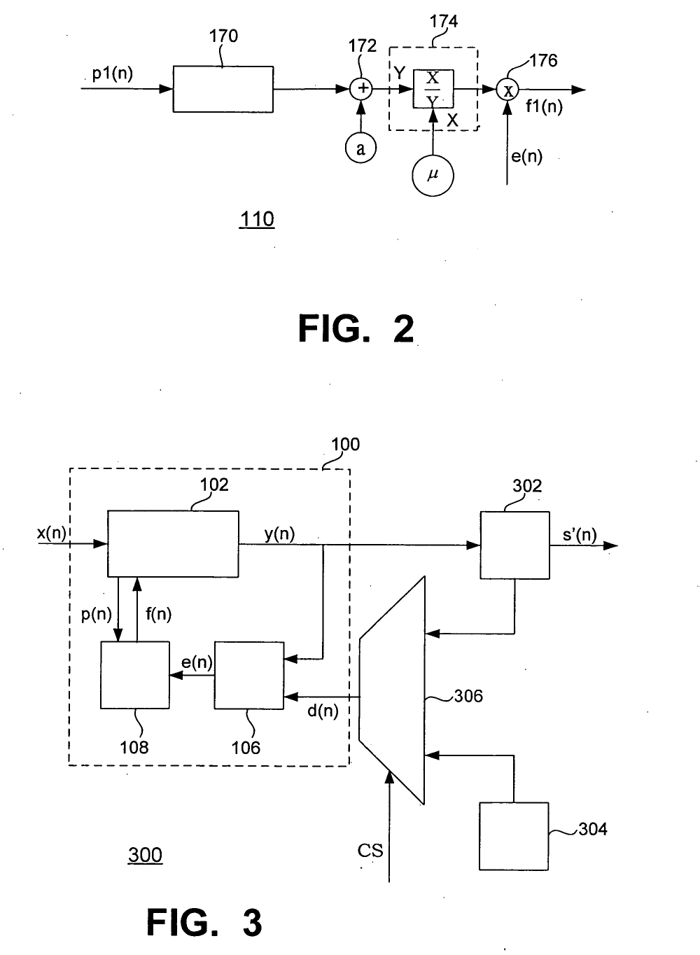

FIG. 2 is a block diagram of one embodiment of the adaptive algorithmic device 110 shown in FIG. 1. Note that the adaptive algorithmic device 112, 114, and 116 are similar and omitted here for conciseness. The adaptive algorithmic device 110 may include a power-computing unit 170 for computing a power value of the pre-whitened signal p1(n). The adaptive algorithmic device 110 may further include an adder 172 for adding the power value, computed by power-computing device 170, with a predetermined constant a to obtain a non-zero first temporary value. The adaptive algorithmic device 110 may still further include a divider 174 for dividing a step size constant μ by the first temporary value to obtain a second temporary value for performing a normalization operation. The adaptive algorithmic device 110 may further include a multiplier 176 for multiplying the second temporary value by the error signal e(n) to obtain a feedback signal f1(n), and the feedback signal f1(n) is used for adjusting the filter coefficient.

FIG. 3 is a block diagram of an equalizer 300 in accordance with an embodiment of the present invention. The equalizer 300 includes the filter device 102, the computing device 106, and the adaptive algorithmic device 108 as described above. The equalizer 300 may further include a decision device 302, a signal generator 304, and a multiplexer 306. The multiplexer 306 is controlled by a signal CS and selects one of the signals, generated by the decision device 302 and the signal generator 304, as a reference signal d′(n). The decision device 302 chooses one of a plurality of predetermined signals as the output signal s′(n) of equalizer 300 by comparing the restored signal y(n) with the plurality of predetermined signals. The output signal s′(n) is also sent back to the multiplexer 306. In the training stage of the adaptive filter 100, a training signal generated by signal generator 304 may be used as the reference signal d(n). After the training stage, the output signal s′(n) chosen by the decision device 302 is used as the reference signal d(n).

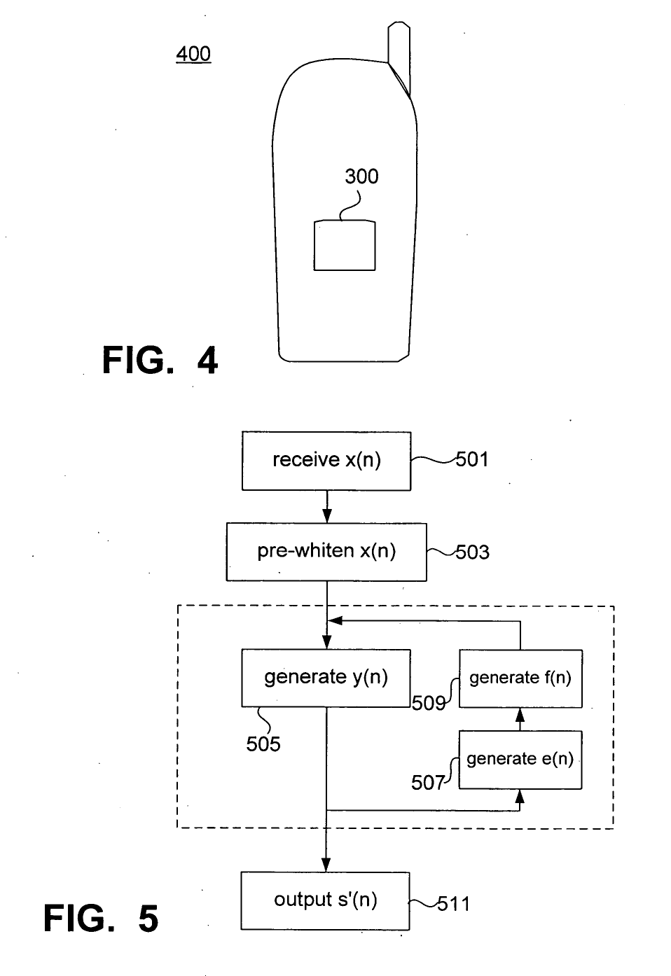

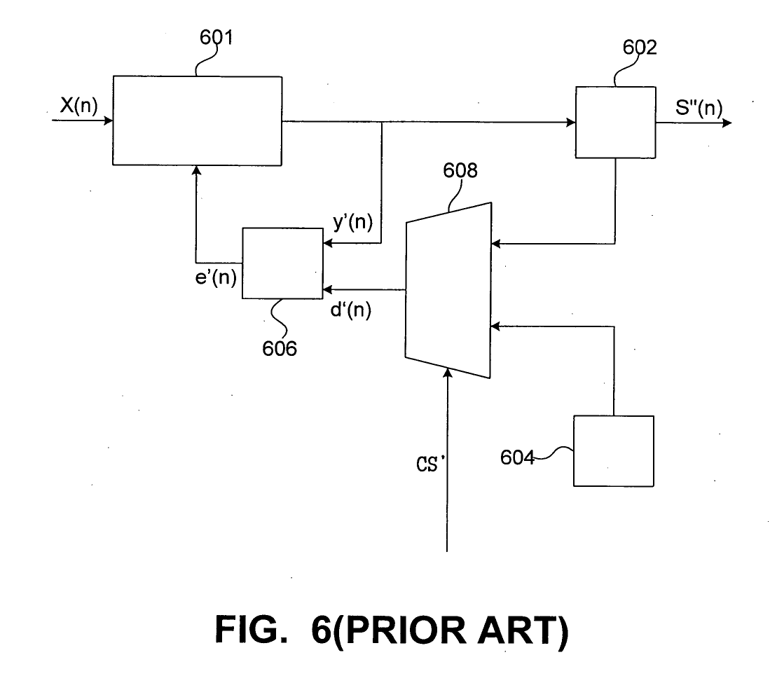

FIG. 4 is a schematic view of a wireless communication device 400 in accordance with an embodiment of the present invention. In this embodiment, the wireless communication device 400 includes the equalizer 300 as described above.

FIG. 5 is a flowchart of a decision feedback equalization method in accordance with an embodiment of the present invention. In this embodiment, an (n)-iterations decision feedback equalization method includes the following steps: Receiving an input signal x(n) (step 501). The input signal x(n) is generated from a source signal s(n) by a channel having a transfer function H(z). The input signal x(n) is pre-whitened to generate a pre-whitened signal p(n) (step 503). In this embodiment, the step 503 may adopt Walsh-Hadamard Transform (WHT). In other embodiments, however, the step 503 may adopt Discrete Fourier Transform (DFT), Real Discrete Fourier Transform (RDFT), Discrete Hartley Transform (DHT), Discrete Cosine Transform (DCT), discrete Sine Transform (DST), or the like.

The pre-whitened signal p(n) is then processed with a decision feedback equalization including the (n)-iterations to generate an output signal s′(n) corresponding to the source signal s(n). Each of the (n)-iterations includes the following steps: A restored signal y(n) is generated (step 505). The error signal e(n) is generated by comparing the restored signal y(n) with a reference signal d(n) (step 507). The feedback signal f(n) is generated based on the error signal e(n) (step 509). The feedback signal f(n) is generated by multiplying a step size constant μ by the error signal e(n), and then divided by a power value of the whitened signal p(n). The reference signal y(n) may be either the source signal (n), or one of a plurality of predetermined signals determined by comparing the restored signal y(n) and the plurality of predetermined signals. At last, one of the plurality of predetermined signal is chosen and outputted as the output signal s′(n) by comparing the restored signal y(n) and the plurality of predetermined signals (step 511).

The spirit and scope of the present invention can be clearly understood by the above detail descriptions of the preferred embodiments. The embodiments are not intended to construe the scope of the invention. Contrarily, various modifications of the illustrative embodiments, as well as other embodiments of the invention, will be apparent to persons skilled in the art upon reference to this description. It is therefore contemplated that the appended claims will cover any such modifications or embodiments as falling within the true scope of the invention.

1. A transform domain adaptive filter (TDAF) for improving convergence speed of an output signal of the TDAF, comprising:
a filter device having a transform matrix device for pre-whitening an input signal to obtain a pre-whitened signal, the filter device restoring the pre-whitened signal and outputting an restored signal;
a computing device for comparing the restored signal with a reference signal to obtain an error signal; and
an adaptive algorithmic device, responsive to the error signal, for adjusting a filter coefficient of the filter device;
wherein the adaptive algorithmic device adopts a normalized least mean square (NLMS) algorithm.

2. The transform domain adaptive filter of claim 1, wherein the transform matrix device adopts Walsh-Hadamard Transform (WHT).

3. The transform domain adaptive filter of claim 1, wherein the adaptive algorithmic device further utilizes the pre-whitened signal for adjusting the filter coefficient.

4. The transform domain adaptive filter of claim 3, wherein the adaptive algorithmic device further comprises a power-computing unit for computing a power value of the pre-whitened signal.

5. The transform domain adaptive filter of claim 4, wherein the adaptive algorithmic device further comprises an adder for adding the power value with a predetermined constant to obtain a non-zero first temporary value.

6. The transform domain adaptive filter of claim 5, wherein the adaptive algorithmic device further comprises a divider for dividing a step size constant by the first temporary value to obtain a second temporary value for performing normalization operation.

7. The transform domain adaptive filter of claim 6, wherein the adaptive algorithmic device further comprises a multiplier for multiplying the second temporary value by the error signal to obtain a feedback signal, and the feedback signal is used for adjusting the filter coefficient.

8. An equalizer for improving convergence speed of an output signal of a transform domain adaptive filter (TDAF), comprising:
a filter device having a transform matrix device for pre-whitening an input signal to obtain a pre-whitened signal, the filter device restoring the pre-whitened signal and outputting a restored signal.

9. The equalizer of claim 8, further comprising:
a computing device for comparing the restored signal with a reference signal to obtain an error signal; and
an adaptive algorithmic device, responsive to the error signal, for adjusting a filter coefficient of the filter device;
wherein the adaptive algorithmic device adopts a normalized least mean square (NLMS) algorithm.

10. The equalizer of claim 9, wherein the transform matrix device adopts Walsh-Hadamard Transform (WHT).

11. The equalizer of claim 9, further comprising:
a decision device for choosing one of a plurality of predetermined signals as the reference signal by comparing the restored signal with the plurality of predetermined signals.

12. The equalizer of claim 9, further comprising a signal generator for generating the reference signal.

13. The equalizer of claim 9, wherein the adaptive algorithmic device further utilizes the pre-whitened signal for adjusting the filter coefficient.

14. The equalizer of claim 13, wherein the adaptive algorithmic device further comprises a power-computing unit for computing a power value of the pre-whitened signal.

15. The equalizer of claim 14, wherein the adaptive algorithmic device further comprises an adder for adding the power value with a predetermined constant to obtain a non-zero first temporary value.

16. The equalizer of claim 15, wherein the adaptive algorithmic device further comprises a divider for dividing a step size constant by the first temporary value to obtain a second temporary value for performing normalization.

17. The equalizer of claim 16, wherein the adaptive algorithmic device further comprises a multiplier for multiplying the second temporary value by the error signal to obtain a feedback signal, and the feedback signal is used for adjusting the filter coefficient.

18. A wireless communication device, comprising:
an equalizer including a filter device, the filter device having a transform matrix device for pre-whitening a signal to obtain a pre-whitened signal, the filter device restoring the pre-whitened signal and outputting a restored signal.

19. The wireless communication device of claim 18, further comprising:
a computing device for comparing the restored signal with a reference signal to obtain an error signal; and
an adaptive algorithmic device, responsive to the error signal, for adjusting a filter coefficient of the filter device;
wherein the adaptive algorithmic device adopts a normalized least mean square (NLMS) algorithm.

20. The wireless communication device of claim 19, wherein the transform matrix device adopts Walsh-Hadamard Transform (WHT).

21. The wireless communication device of claim 19, wherein the adaptive algorithmic device further utilizes the pre-whitened signal for adjusting the filter coefficient.

22. The wireless communication device of claim 21, wherein the adaptive algorithmic device further comprises a power-computing unit for computing a power value of the pre-whitened signal.

23. The wireless communication device of claim 22, wherein the adaptive algorithmic device further comprises an adder for adding the power value with a predetermined constant to obtain a non-zero first temporary value.

24. The wireless communication device of claim 23, wherein the adaptive algorithmic device further comprises a divider for dividing a step size constant by the first temporary value to obtain a second temporary value for performing normalization.

25. The wireless communication device of claim 24, wherein the adaptive algorithmic device further comprises a multiplier for multiplying the second temporary value by the error signal to obtain a feedback signal, and the feedback signal is used for adjusting the filter coefficient.

26. An (n)-iterations decision feedback equalization method for an input signal x(n), the input signal x(n) being generated from a source signal s(n) by a channel having a transfer function H(z), the method comprise the steps of:
pre-whitening the input signal x(n) to generate a pre-whitened signal p(n); and
processing the pre-whitened signal p(n) with a decision feedback equalization including the (n)-iterations to generate an output signal s′(n) corresponding to the source signal s(n), each of the (n)-iterations generating a restored signal y(n), an error signal e(n), and a feedback signal f(n), the error signal e(n) being generated by comparing the restored signal y(n) with a reference signal d(n), the feedback signal f(n) being generated based on the error signal e(n);
wherein the feedback signal f(n) is generated by multiplying a step size constant μ by the error signal e(n), and then divided by a power value of the whitened signal p(n).

27. The method of claim 26, wherein the step of pre-whitening adopts Walsh-Hadamard Transform (WHT).

28. The method of claim 26, wherein the reference signal d(n) is equal to the source signal s(n).

29. The method of claim 26, wherein the reference signal d(n) is generated by the following steps:
comparing the restored signal y(n) with a plurality of predetermined signals; and
outputting one of the predetermined signals as the reference signal.
